(19) United States
(12) Patent Application Publication
(10) Pub. No.: US 2026/0151911 A1
(43) Pub. Date: Jun. 4, 2026

(54) GLOVE CORRESPONDING TO MULTI-FINGERED ROBOTIC HAND

(71) Applicant: GDM Holding LLC, Mountain View, CA (US)

(72) Inventors: Jose Enrique Chen, London (GB); Murilo F. Martins, London (GB); Nicolas Manfred Otto Heess, London (GB); Serkan Cabi, London (GB); Francesco Nori, London (GB); Mustafa Emre Karagozler, London (GB); Stefano Saliceti, London (GB)

(21) Appl. No.: 19/189,827

(22) Filed: Apr. 25, 2025

Related U.S. Application Data
(60) Provisional application No. 63/726,441, filed on Nov. 29, 2024.

(51) Int. Cl. B25J 9/16; B25J 3/04; B25J 13/02; B25J 13/08; B25J 15/10

(52) U.S. Cl. CPC B25J 9/1669; B25J 3/04; B25J 9/1605; B25J 9/163; B25J 13/02; B25J 13/084; B25J 13/088; B25J 15/10

(57) ABSTRACT

An apparatus and method for a glove having kinematic movement corresponding to a robotic hand.

### BACKGROUND

Typical wearable gloves utilize multiple sensors that correspond to movement of the hand and/or fingers, where such movement extends beyond the available movement or restrictions of a corresponding robotic hand for which the wearable glove is being utilized. For example, the wearable glove can be utilized in puppetry control and/or teleoperation of the robotic hand, in generating training data for training a machine learning model for controlling the robotic hand, in controlling a simulation variant of the robotic hand, etc.

This variation in movement between a wearable glove and a corresponding robotic hand may lead to excess information/movement/learning/control not applicable to the robotic hand. This may hinder the robot's hand learning and training, damage the robotic hand/arm, or portions thereof, and/or the capturing of bad data associated with the object being manipulated. For example, variations in kinematic constraints between a wearable glove and a corresponding robotic hand can require mapping of movements, via the wearable glove, to distinct kinematics of the corresponding robotic hand. Such mapping can be imprecise and/or inaccurate, leading to significant differences between the wearable glove movements and corresponding robotic hand movements.

### SUMMARY

Implementations disclosed herein relate to the glove's kinematics conforming to the kinematics of the robotic hand. The kinematics of the glove conform, limit, or restrict the actual movement of the hand or fingers during utilization by the user. The glove's limitations or restrictions may include joint positions and/or linkage positions to limit or define the kinematics of the one or more user's fingers to reflect the robotic hand's kinematics.

In some implementations, a glove may have kinematics corresponding to a robotic hand. In various implementations, the glove may include at least two sets of finger linkages. In some implementations, a first set of at least two sets of finger linkages includes at least one first joint between finger linkages therein. In various implementations, at least one first joint includes at least one restriction of movement conforming to a corresponding at least one physical joint of at least one set of robotic finger linkages of a robotic hand.

In addition, in some implementations, at least one first joint includes at least one encoder. In various implementations, at least one first joint may be a physical joint corresponding to at least one physical joint of at least one set of robotic finger linkages of the robotic hand. In some implementations, at least one first joint defines a virtual joint corresponding to at least one physical joint of at least one set of robotic finger linkages of the robotic hand. In various implementations, the first set of at least two sets of finger linkages may include at least one second joint between finger linkages therein, wherein at least one second joint defines a virtual joint, wherein the virtual joint includes at least one restriction of movement conforming to a corresponding at least one second physical joint of at least one set of robotic finger linkages of the robotic hand and wherein at least one first joint is a physical joint corresponding to at least one physical joint of at least one set of robotic finger linkages of the robotic hand. In some implementations, the first set of at least two sets of finger linkages may be configured to engage the thumb of the user or the finger of the user. In various implementations, the glove may include a wrist attachment and a frame member, wherein at least two sets of finger linkages extend from the frame member, and wherein the wrist attachment and at least two sets of finger linkages may be configured to be the only points of contact with the user.

In some implementations, a method of capturing kinematic movement of a glove corresponding to the kinematic movement of a robotic hand may include providing a glove with one or more finger linkages interconnected by one or more physical joints, wherein the one or more physical joints define one or more virtual joints, and wherein the one or more physical joints and the one or more virtual joints correspond to one or more physical joints of a robotic hand, wherein kinematic movement of the one of more finger linkages of the glove conform to the one or more physical joints of the robotic hand to reduce unwanted kinematic movement and data that cannot be completed by the robotic hand. In various implementations, the method may include capturing data by one or more sensors during the kinematic movement of the glove from user interaction with the glove. In some implementations, the method may include transmitting the captured data.

In addition, in some implementations, the captured data may be used for training one or more machine learning models for use in controlling the robotic hand. In various implementations, the one or more finger linkages of the glove may include one or more tactile members. In some implementations, the method may include capturing tactile data from the one or more tactile members. In some implementations, the glove may include one or more tactile sensors. In various implementations, capturing data from kinematic movement of the one or more finger linkages may be free from restrictions from kinematics of the wrist of the user. In some implementations, the one or more finger linkages may include a proximal end and a distal end, wherein the one or more virtual joints are more proximal to the proximal end than the one or more physical joints corresponding to the one or more physical joints of the robotic hand. In various implementations, the one or more finger linkages may include a proximal end and a distal end, wherein the one or more virtual joints are positioned between at least one first physical joint of the one or more physical joints adjacent the proximal end and at least one second physical joint of the one or more physical joints adjacent the distal end corresponding to the one or more physical joints of the robotic hand. In various implementations, at least one first physical joint may be transverse to the one or more virtual joints and at least one second physical joint. In some implementations, the glove may include a plurality of the one or more finger linkages. In various implementations, the method may include at least one of direct glove use, true puppetry use, and/or SIM use.

In some implementations, human demonstrations are collected where each of the human demonstrations includes a respective human directly manipulating an object with a respective glove that mimics a robotic hand, such as respective glove(s) that conform to implementations disclosed herein. This minimizes the kinematic gap between the data collected in the real-world, via the human demonstrations, and simulation. The collected real-world human demonstrations can then be adapted to a simulation environment. For example, they can be adapted to the simulation environment through the use of trajectory optimization to obtain dynamically feasible trajectories. The adaptations to the simulation environment can then be utilized to efficiently learn real robot policies. For example, curriculum learning can be utilized to efficiently learn generalizable policies that transfer to a real robot.

As a particular example, assume that a human demonstrator wears a glove on one hand. Joint poses of the glove fingers, hand poses, and object poses can be recorded as the demonstrator performs manipulation tasks. The recorded measurements are synchronized and transformed into a consistent coordinate frame for accurate visualization in simulation. Using a robotic simulator (e.g., MuJoCo), feasible trajectories can be solved in simulation, referencing the demonstrated trajectories from the recorded measurements. This can be formulated as a control optimization problem with objectives to match reference trajectories and constraints on system dynamics. The goal is to generate dynamically feasible trajectories in simulation that mimic the demonstrations. Given the optimal simulated trajectories, reinforcement learning, such as curriculum learning, can be utilized to efficiently learn generalizable policies. The learned policies can be capable of completing tasks sampled from a broader distribution in simulation. With domain randomization, the learned policies can be transferred to the real-world setup with zero-shot. The learned policies can successfully complete tasks performed via real-world robots.

In some implementations, a glove may include a frame member. In various implementations, the glove may include one or more first finger linkages interconnected by one or more first physical joints and projecting from the frame member, wherein the one or more first physical joints correspond to one or more first robotic physical joints of a robotic hand. In some implementations, the glove may include one or more second finger linkages interconnected by one or more second physical joints and projecting from the frame member, wherein the one or more second physical joints correspond to one or more second robotic physical joints of a robotic hand. In some implementations, at least one of the one or more first physical joints and/or the one or more second physical joints may define one or more virtual joints, wherein the one or more virtual joints correspond to one or more third robotic physical joints of a robotic hand. In various implementations, the one or more first physical joints may include at least one first restriction of movement conforming to the one or more first robotic physical joints. In some implementations, the one or more second physical joints may include at least one second restriction of movement conforming to the one or more second robotic physical joints. In various implementations, the one or more virtual joints may include at least one third restriction of movement conforming to the one or more third robotic physical joints.

In addition, in some implementations, the glove may include a wrist attachment configured to engage the forearm of the user when the one or more first finger linkages and the one or more second finger linkages are configured to engage the finger of the user, respectively. In various implementations, the frame member may be configured to be spaced from the hand of the user. In some implementations, the one or more first finger linkages may include a distal phalange linkage connected to a middle phalange linkage, and wherein each one of the distal phalange linkage and the middle phalange linkage includes a tactile member.

Implementations may include tactile sensations of feedback from the user's fingers. The middle and/or distal phalange, for example, may include a tactile member or a silicone surface contact to feel and react to the object. The shore hardness and/or friction of the surface contact or tactile member may be similar to the robotic hand. However, the shore hardness may increase in the direction towards the user's finger. The shore hardness of the tactile member may be larger than the shore hardness of the robotic hand material used for contacting objects. Custom molded tactile members may be used.

In some implementations, a plurality of finger linkages may be used in the glove to allow movement of the one or more phalanges that would otherwise interfere with receiving the user's fingers and movement of the fingers during kinematic movement matching the robotic hand. The plurality of finger linkages may define a virtual joint corresponding to a physical joint of the robotic hand. In some implementations, the glove may include spaced attachments on opposing sides of the user's wrist allowing manipulation of the glove phalanges/stalls or kinematics rather than be affected by or limited by the movement of the wrist.

The above description is provided as an overview of some implementations of the present disclosure. Further description of those implementations, and other implementations, are described in more detail below.

### BRIEF DESCRIPTION OF THE DRAWINGS

FIG. 1 illustrates an example application in which implementations described herein can be implemented between one embodiment of a glove and a robotic hand, illustrating one or more joints and/or linkages of the glove corresponding to one or more joints and/or linkages of the robotic hand.

FIG. 2 is a perspective view of the glove shown in FIG. 1 with portions of the glove broken away.

FIG. 3 is a perspective view of a set of finger linkages (e.g. first, third, both) of the glove shown in FIG. 1 illustrating one or more physical joints corresponding to one or more physical joints of the robotic hand.

FIG. 4 is another perspective of the finger linkages of the glove shown in FIG. 3 with portions broken away to illustrate one or more tactile members.

FIG. 5 is a perspective view of another set of finger linkages (e.g. second) of the glove shown in FIG. 1 Illustrating a virtual joint and one or more physical joints corresponding to one or more physical joints of the robotic hand.

### DETAILED DESCRIPTION

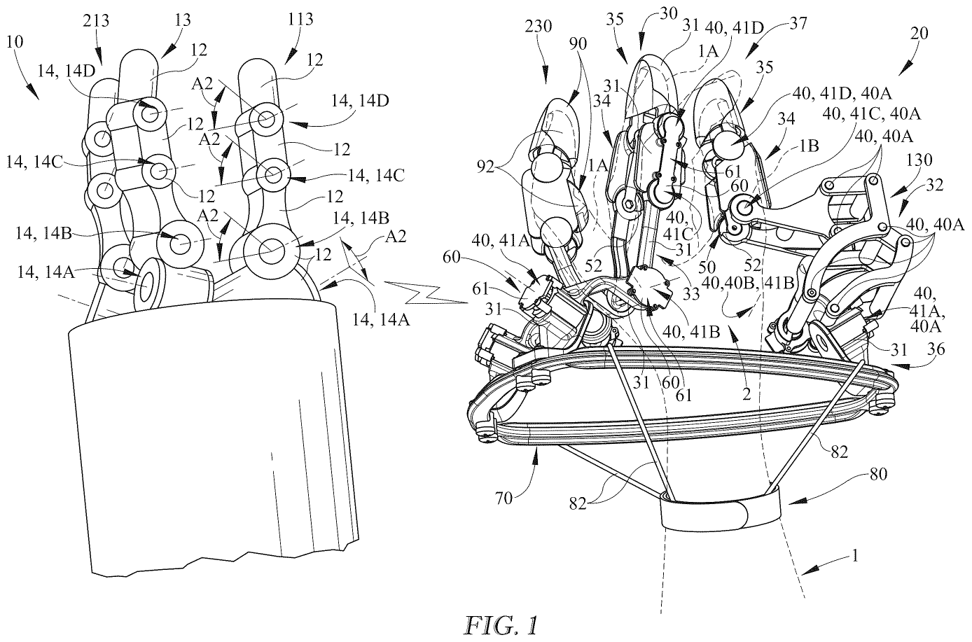

As shown in the Figures, a wearable glove 20 may be used to provide kinematic movement and corresponding data conforming to the kinematic movement of a robotic hand 10. One example of the robotic hand 10, may be but is not limited to the DEX-EE Hand as shown in FIG. 1. The glove 20 or one or more finger linkages 30, 130, 230 of the glove 20 may conform to or include the same linkage length(s) or ratio(s) (e.g. conforming or maintaining the positions of the one or more joint/pivot axis relative to each other), the joint limits (e.g. pivoting limits, +/−degree of movement, limitations, restrictions), preserve the relative position of the robotic fingers/linkages, and/or relevant contacts to mirror or correspond to the linkages 13, 113, 213 or kinematic movement of the robotic or mechanical hand 10. For example, the joint(s) 40, 41A-41D (e.g. physical, virtual, or both) of the glove 20 may be a 1 to 1 mapping to the joint(s) 14, 14A-14D of the robotic hand 10. The glove 20 may allow the user 1 to feel the kinematic limits or range thereof of the glove 20 and/or tactile sensations from the fingers/thumb 1A, 1B. The glove 20 may provide kinematic movement and/or data that is captured and/or transmitted for a variety of applications. Because of the conforming kinematics between the glove 20 and robotic hand 10, the glove's kinematic movement and/or data may be free from undesirable, unwanted, or superfluous glove movements and/or data (e.g. movement or alignment outside the joint/linkage limits/lengths/ratios that the robotic hand cannot achieve/complete/operate). These applications include, but are not limited to, direct glove use (e.g. user controls puppet to perform a task while directly interacting with objects), true puppetry/Teleop (e.g. user controls the DEXHand or robotic hand directly using the glove to perform task(s) directed toward object(s) without direct interaction between the glove and the object(s)), and/or SIM (e.g. user controls puppet to do tasks in a simulated environment).

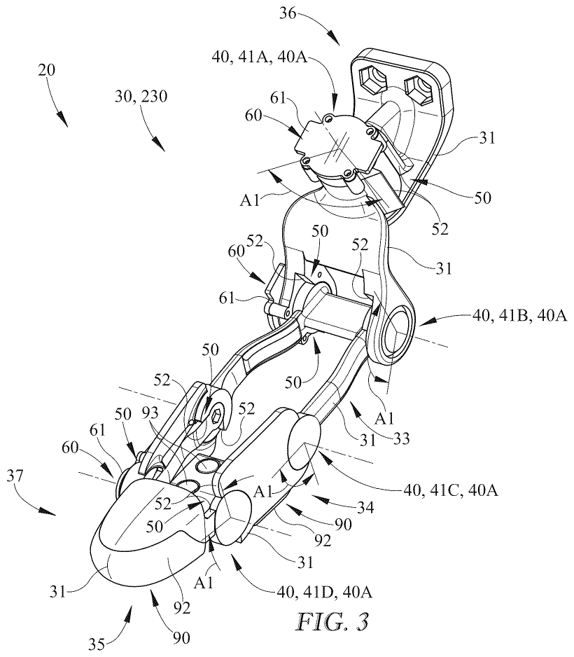

In some implementations, the glove 20 may include one or more finger linkages or sets of linkages (e.g. first set of finger linkages 30 engaging a finger 1A, second set of finger linkages 130 engaging a thumb 1B, third set of finger linkages 230 engaging another finger 1A etc.). As shown in FIG. 1, the finger linkages 30, 130, 230 may engage one or more appendages, fingers 1A, and/or thumb 1B, or portions thereof, of the user's hand 2. The term “finger” as used herein includes one or more phalanges (e.g. the finger(s), thumb, both). The glove 20 may include one or more sets of finger linkages (e.g. first 30, second 130, third 230, etc.). The glove 20 may include at least two sets of finger linkages (e.g. first 30, second 130). The sets of finger linkages may be the same or different in some implementations. A first set of fingers linkages 30 may not be the same as the second set of finger linkages 130 in some implementations. The first set of linkages may be the same as another or third set of finger linkages 230 in some implementations as shown in FIGS. 1-4. As shown in the one embodiment in the Figures, the glove includes a plurality of finger linkages 30, 130, 230. The glove 20 may include three sets of finger linkages (e.g. first, second, and a third set of finger linkages). The first and third sets of finger linkages 30, 230 (e.g. finger engagement, finger stall, linkages, joints) may be the same. The first and third sets of finger linkages 30, 230 (e.g. finger stall) may be different from the second set of finger linkages 130 (e.g. thumb engagement, thumb stall, linkages, joints), if used. The finger linkages or set 30, 130, 230 may include one or more linkages 31 (e.g. corresponding to a robotic hand linkage 12, first set of robotic linkages 13, second set of robotic linkages 113, third set of robotic linkages 213) connected by one or more joints 40 (e.g. pivoting). The joints 40, 41A-41D of the glove 20 may correspond to the joints 14, 14A-14D of the robotic hand 10. Although a glove's single linkage 31 may correspond to a single robotic linkage 12, a plurality of glove linkages 31 (e.g. four-bar mechanism(s) 32) may correspond to a single robotic linkage 12. The finger linkages 31 or set 30, 130, 230 may include at least a proximal phalange linkage 33, middle phalange linkage 34, and/or a distal phalange linkage 35. The glove linkage(s) 31 and/or joint(s) 40 may conform to or be substantially the same length/ratios as the linkages 12 and/or joint(s) 14 of the robotic hand 10. The joint(s) 40, 41A-41D (e.g. virtual, physical, both, first, second, third, etc.) may include one or more stops/limits/restrictions 50 (e.g. determining a range of motion about an axis, angle A1, degree of freedom) mirroring or conforming to the respective joint(s) 14, 14A-14D (e.g. physical, stops, limits, restrictions, range of motion, angle A2) of the robotic hand 10. The one or more restrictions 50 or restriction of movement (e.g. joint limits) may include one or more hard stops/abutments/protrusions 52 (e.g. opposing stops) projecting from one or more linkages 31 adjacent the joint or pivoting pin 40. The one or more hard stops or protrusions 52 or restriction 50 of at least one linkage 31 may stop or define the angle or pivoting range A1 (e.g. extent, boundary) of the linkage 31 by engaging another or adjacent linkage 31, or portion thereof (e.g. stop(s) 52, restriction 50). The hard stop(s) 52 or restriction(s) 50 of the one or more joints 40 (e.g. physical, virtual, both) may allow or define a degree of freedom or angle A1 for which the adjacent linkage 31 may pivot. The angle A1 or pivoting range of the glove 20 (e.g. joints 40, linkage(s) 31) may conform (e.g. identical, substantially the same) to the angle A2 or pivoting range of the robotic hand 10, or portions thereof (e.g. linkage(s) 12, joints 14). As used herein, the glove 20, pivoting/restriction 50 limits, and/or angle A1, or portions thereof, may “conform” within +/−one or more degrees of the pivoting angle A2 or degrees of freedom of the joint movement of the robotic hand 10 to maintain substantially the same kinematic movement. For example, the angle A1 or pivoting range of the glove, or portions thereof, may be within, but is not limited to, +/−1 degrees, +/−2 degrees, +/−3 degrees, +/−4 degrees, +/−5 degrees, +/−6 degrees +/−7 degrees, +/−8 degrees, +/−9 degrees, and/or +/−10 degrees of the angle A2 or pivoting range of the robotic hand 10, or portions thereof, and still be within the scope of the invention.

In some implementations, the glove 20 may include one or more sensors 60. The linkage(s) 31 and/or joint(s) 40 may include one or more sensors 60. The one or more sensors 60 may capture kinetic movement of one or more portions (e.g. joint(s), linkage(s)) of the one or more finger linkages 30, 130, 230 or glove 20 from the user interaction with the glove 20, or portions thereof. The one or more sensors 60 may be one or more encoders 61. The one or more encoders 61 may capture 12 degrees of freedom joint positions on the three finger linkages/sets 30, 130, 230 of the glove 20. The captured data by the one or more sensors 60 may be transmitted from the glove 20 or user 1. The captured data may be used for training the robotic hand 10 in some applications. A variety of sensors may be used and still be within the scope of the invention.

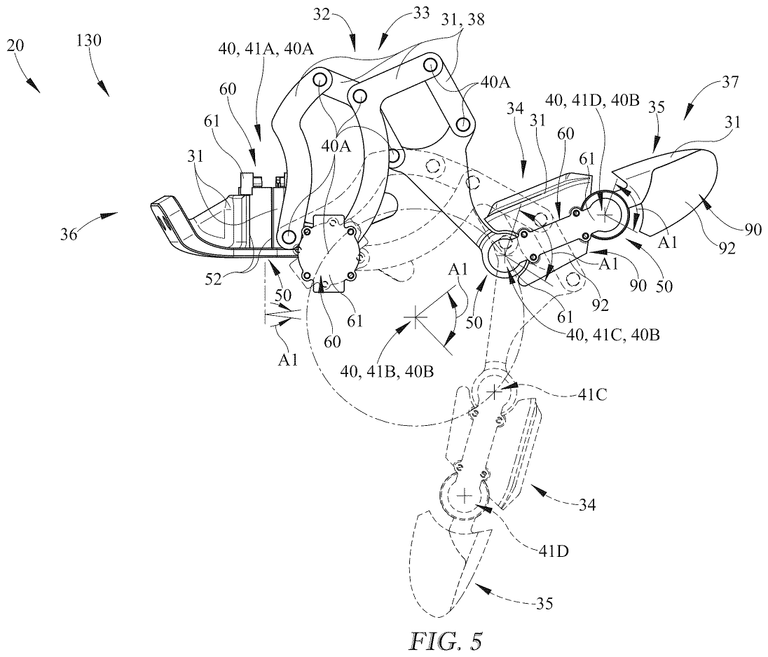

In some implementations, the glove 20 and/or one or more finger linkages 30, 130, 230 may include one or more joints 40 (e.g. virtual 40B, physical 40A, both) interconnected, between, or defined by one or more linkages 31. The joints 40 may include one or more physical joints 40A and/or one or more virtual joints 40B. The one or more physical joints 40A may be positioned between or interconnect two or more linkages 31 of the one or more finger linkages 30, 130, 230. The one or more physical joints 40A (e.g. first joint, second joint, etc.) of the glove 20 may correspond to one or more physical joints 14, 14A-14D (e.g. robotic, first joint, second joint, etc.) of the robotic hand 10. The one or more physical joints 40A (e.g. second joint, first joint) of the glove 20 may define one or more virtual joints 40B. The one or more virtual joints 40B (e.g. 41B) defined by the glove 20, or portions thereof (e.g. physical joint(s) 40A, four bar mechanism 32, linkages), correspond to one or more physical joints 14, 14A-14D (e.g. third, robotic) of the robotic hand 10. The one or more physical joints 40A/linkages 31 (e.g. four bar mechanism 32) defining the virtual joint(s) 40B (e.g. 41B) may not correspond directly to a physical joint 14A-14D and/or linkage 12 of the robotic hand 10. As shown in the one embodiment in FIGS. 1-4, the first and third finger linkage sets 30, 230 include all physical joints 40A, 41A-41D (e.g. first joints) corresponding to the physical joints 14, 14A-14D of the robotic hand 10. As shown in FIG. 5, the second finger linkage set 130 includes both physical joint(s) 40A, 41A, 41C, 41D (e.g. first joints) and virtual joint(s) 40B, 41B (e.g. defined by second joints or first joints) corresponding to the physical joints 14A-14D (e.g. third, robotic) of the robotic hand 10. Virtual joint 41B may correspond to physical joint 14B of the robotic hand 10. The virtual joint 41B may be positioned along the length of the finger linkage 130 between physical joints 41A and 41C, 41D. As used herein, the glove 20, linkage lengths, and/or pivoting joints/axis (e.g. physical, virtual (if used), both), or portions thereof, may “conform” by being substantially identical (e. g. 1 to 1) to the robotic hand 10, linkage lengths, and/or physical joints/axis to preserve the relative position of the one or more physical axis of the robotic hand. It should be understood that the corresponding one or more axes or joints between the glove and robotic hand may be varied by, but is not limited to, one or more distances (e.g. at least 10 mm, at least 5 mm, at least 1 mm, at least 0.5 mm) and still be within the scope of the invention.

In some implementations, the one or finger linkages 30, 130, 230 and/or glove 20 includes a proximal end 36 and a distal end 37 (e.g. free end). The proximal end 36 may be adjacent the wrist/first attachment 80 and/or a frame member 70. If a finger linkage 130 includes a virtual joint 40B, the virtual joint 40B (e.g. 41B), or the physical joints/linkages defining the virtual joint (e.g. four bar mechanism 32), may be more proximal to or adjacent the proximal end 36 than one or more physical joints 41C, 41D of linkages of the glove 20 corresponding to the physical joints 14C, 14D of the robotic hand 10. For example as shown in the Figures, the second set of finger linkages 130 may include virtual joint 41B between physical joints 41C, 41D (e.g. first) of the glove 20 adjacent the distal end 37 corresponding to the physical joints 14C, 14D of the robotic hand 10 and physical joints 41A (e.g. second) of the glove 20 adjacent the proximal end 36 corresponding to the physical joints 14A, 14B of the robotic hand 10. The first physical joint 41A (e.g. axis), adjacent the proximal end 36 or frame member 70, may be transverse to the virtual joint(s) 41B (e.g. axis), if used, and/or the second physical joints 41B-41D (e.g. axis), adjacent the distal end 37 or away from the proximal end 36.

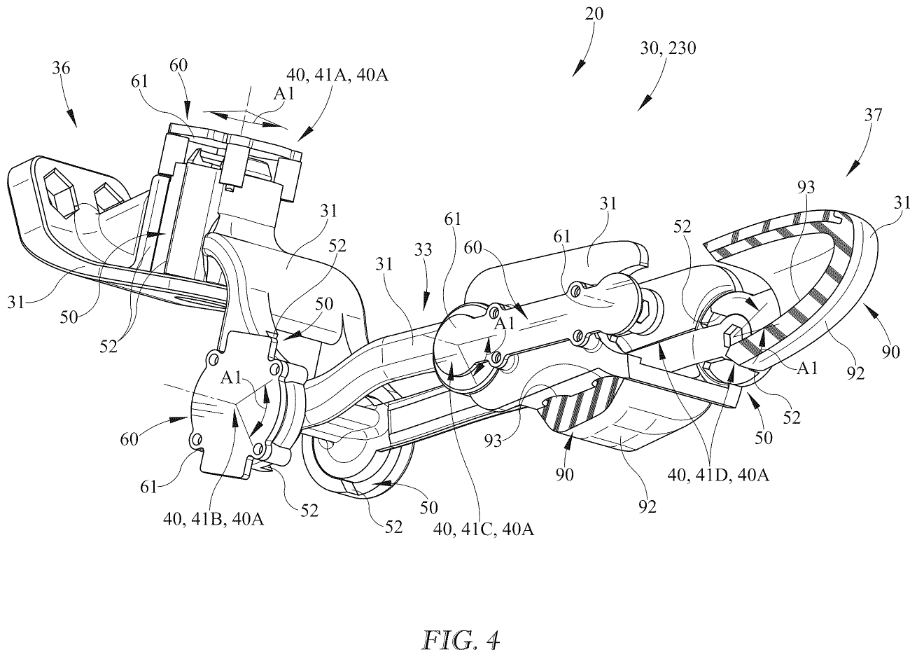

In some implementations, the captured data and/or transmitted captured data may be tactile data from the one or more tactile members 90, tactile sensor(s), glove 20, or portions thereof, and/or kinematic movement of the glove 20 (e.g. linkages, joints). The glove 20, linkages 31, and/or one or more finger linkages 30, 130, 230 may include one or more tactile members 90. The tactile members 90 may include contact surfaces 92 on the one or more linkages 31 (e.g. middle phalanges, distal phalanges) of the finger linkages 30, 130, 230. The one or more tactile members 90 may allow the user to feel the object. The user may feel the object through the tactile member 90. One or more tactile sensors, if used, may be coupled to the tactile members 90 and/or contact surfaces 92, or portions of the glove 20, to capture data and/or transmit captured data. As shown in FIG. 4, the tactile member 90 may extend from the contact surface 92 of the glove/linkage to (e.g. inwardly) the user's finger 1A, 1B surfaces (e.g. finger tips, middle, distal, proximal). The material of the tactile member 90 may be a polymer or silicone (e.g. soft) material. The shore hardness and/or friction may be similar to or correspond to the robotic hand material used for contacting objects. For example, the shore hardness may be about 70 A. In some implementations, the shore hardness may increase from the contact surface 92 of the tactile member 90 towards the user's finger (e.g. interior surface 93) or away from the contact surface 92. In some implementations, the shore hardness of the tactile member 90 may be harder or larger than the shore hardness of the robotic hand material used for contacting objects. The larger shore hardness of the material of the tactile member 60 may compensate for the finger cavity or receptacle that may allow for undesirable deformation as compared to the solid structure of the robotic linkages. In some implementations, the tactile member 90 may be molded (e.g. custom) to fit a user's finger/thumb 1A, 1B, or portion thereof. The tactile member 90 of the distal phalange linkage 35 or stall portion may surround (e.g. substantially 360 degrees, distal end, both) the finger/thumb tip and include a distal end portion, an ulnar portion, a radial portion opposite the ulnar portion, a volar portion, and/or a dorsal portion opposite the volar portion. The tactile member 90 of the middle phalange linkage 34 or stall portion may include an ulnar portion. It should be understood that a variety of shore hardness, materials, and friction coefficients may be used and still be within the scope of the invention.

In some implementations, the glove 20 and/or finger linkages 30, 130, 230 may include one or more linkages 31. The one or more linkages 31 of a finger linkage 30, 130, 230 may engage a portion of the finger (e.g. 1A, 1B) or may not engage a portion of the finger during kinematic movement of the hand/fingers. One or more linkages 31 of the sets of finger linkages 130 may be a kinematic linkage 38 not associated with or contacting a portion of the finger/thumb. As shown in the one embodiment in FIGS. 1-4, the first and third sets of finger linkages 30, 230 (e.g. engaging a finger 1A) may include at least the middle phalange linkage 34 (e.g. engaging the middle phalange) and a distal phalange linkage 35 (e.g. engaging the distal phalange). In some implementations, both the middle phalange linkage 34 and the distal phalange linkage 35 may include one or more tactile members 90. In some implementations as shown in FIGS. 1, 2, and 5, the middle and distal phalange linkages 34, 35, adjacent the distal end 37, extend from a plurality of kinematic linkages 38 (e.g. four bar mechanism 32) adjacent the proximal end 36. As shown in the one embodiment, the second set of finger linkages 130 (e.g. engaging a thumb 1B) may include at least the distal phalange linkage 35 (e.g. engaging the distal phalange). In some implementations, the distal phalange linkage 35 may include one or more tactile members 90. For example, the four bar mechanism 32 or kinematic linkage(s) 38, that define the virtual joint 40B, 41B, may not engage or interfere with the movement of the user's finger/thumb 1A, 1B. The kinematic linkage(s) 38 or four bar mechanism 32 may not mirror the linkage 12 of the robotic hand 10, but preserves the kinematic equivalence and/or maintains the virtual joint 41B in the same position as the robotic hand joint 14B. The distal phalange linkage 35, adjacent the distal end 37, extends from a plurality of kinematic linkages 38 (e.g. four bar mechanism 32) and linkage 31 adjacent the proximal end 36. Linkage(s) 38 and/or physical joints 40A not engaging the finger/thumb 1A, 1B and/or that define (e.g. bar mechanism 32) the virtual joint 40B, 41B may allow for unrestricted movement of the finger(s) 1A or thumb 1B without glove/linkage interference, restriction, or limits placed on the glove's kinematic movement to allow the captured data to correspond to the robotic hand's kinetic movement (e.g. no undesirable/restricted movement not mirroring the robotic hand or incorrect data).

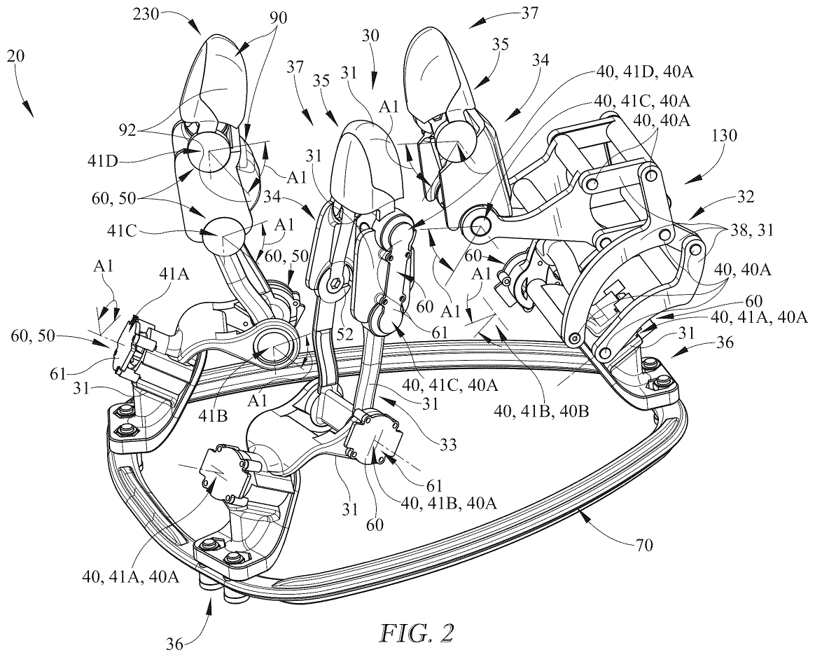

In some implementations, the glove 20 may include a frame member(s) 70. As shown in FIGS. 1 and 2, the frame member 70 may interconnect one or more finger linkages 30, 130, 230 together. The finger linkages 30, 130, 230 project from the frame member 70. The proximal ends 36 of the finger linkages 30, 130, 230 may be adjacent the frame member 70, if used. The frame member 70, if used, may be an annular ring as shown in the one embodiment. As shown in FIG. 1, the frame member 70 may be spaced away from or configured to be spaced from the user's hand 2. The frame member 70 may be substantially rigid to maintain the position of the finger linkages 31/joints 40 relative to each other. The frame member 70 may not directly attach to or contact the user's hand 2 (e.g. palm, dorsal, palmer) or wrist. The frame member 70 may be independent from the user's hand 2 to not interfere with the kinematics of the glove 20 and/or one or more finger linkages 31.

In some implementations, one or more attachments (e.g. first) may be used in addition to the attachment (e.g. second) of the finger linkage(s) 30, 130, 230 to the fingers/thumb. A first or wrist attachment 80, if used, may be used to secure the glove to the hand 2 and/or user 1. As shown in FIG. 1, the wrist attachment may be coupled to the forearm, on the proximal side of the wrist away from the hand 2. The wrist attachment 80 is spaced from the finger linkages 30, 130, 230 attachments at the phalanges. Stated alternatively, the only points of contact or engagement of the glove with the user may be the wrist attachment (e.g. at the forearm) and the second attachment (e.g. at the sets of finger linkages). The wrist attachment 80 may include one or more straps 82. One or more straps 82, if used, may be attached to the frame member 70 and to the wrist attachment 80 (e.g. plastic loop adjustable in size via hooks and loops) may draw or maintain the one or more finger linkages 30, 130, 230 pulled in a direction towards the wrist/forearm of the user. The capturing of data from the kinematic movement of the one or more finger linkages 30, 130, 230 and/or glove 20 may be free from restrictions or undesirable data from the user's wrist (e.g. wrist interference, limiting finger or linkage movement), meta-carpals, and/or carpals. With no attachments or portions of the glove engaging between the forearm (e.g. first attachment) and the fingers/thumb (e.g. second attachment), the captured data of the kinetic movement of the glove is not affected by or limited by the movement of the wrist.

In some implementations, a glove is provided that includes at least two sets of finger linkages. A first set of the at least two sets of finger linkages includes at least one first joint that includes at least one defined restriction of movement. Further, the at least one first joint defines a virtual joint that mimics a physical joint. For example, the physical joint can be of a robotic hand.

In some of those implementations, the at least one first joint includes at least one encoder. In some versions of those implementations, the first set of the at least two sets of finger linkages is configured to engage the thumb of the user or the finger of the user. In some of those or other versions, the first set of the at least two sets of finger linkages is configured to engage the thumb of the user or the finger of the user.

In some implementations, a glove is provided that includes at least two sets of finger linkages. A first set of the at least two sets of finger linkages includes at least one first joint that includes at least one defined restriction of movement. Further, the first set of the at least two sets of finger linkages includes at least one second joint between finger linkages therein. The at least one second joint defines a virtual joint. Optionally, the virtual joint includes at least one restriction of movement conforming to a corresponding physical joint.

In some of those implementations, the at least one first joint includes at least one encoder. In some versions of those implementations, the first set of the at least two sets of finger linkages is configured to engage the thumb of the user or the finger of the user. In some of those or other versions, the first set of the at least two sets of finger linkages is configured to engage the thumb of the user or the finger of the user.

What is claimed is:

1. A glove with kinematics corresponding to a robotic hand, the glove comprising:
at least two sets of finger linkages;
wherein a first set of the at least two sets of finger linkages includes at least one first joint between finger linkages therein; and
the at least one first joint includes at least one restriction of movement conforming to a corresponding at least one physical joint of at least one set of robotic finger linkages of a robotic hand.

2. The glove of claim 1 wherein the at least one first joint includes at least one encoder.

3. The glove of claim 1 wherein the at least one first joint is a physical joint corresponding to the at least one physical joint of the at least one set of robotic finger linkages of the robotic hand.

4. The glove of claim 1 wherein the at least one first joint defines a virtual joint corresponding to the at least one physical joint of the at least one set of robotic finger linkages of the robotic hand.

5. The glove of claim 1 wherein the first set of the at least two sets of finger linkages includes at least one second joint between finger linkages therein, wherein the at least one second joint defines a virtual joint, wherein the virtual joint includes at least one restriction of movement conforming to a corresponding at least one second physical joint of the at least one set of robotic finger linkages of the robotic hand and wherein the at least one first joint is a physical joint corresponding to the at least one physical joint of the at least one set of robotic finger linkages of the robotic hand.

6. The glove of claim 1 wherein the first set of the at least two sets of finger linkages is configured to engage the thumb of the user or the finger of the user.

7. The glove of claim 1 further comprising a wrist attachment and a frame member, wherein the at least two sets of finger linkages extend from the frame member, and wherein the wrist attachment and the at least two sets of finger linkages are configured to be the only points of contact with the user.

8. A method of capturing kinematic movement of a glove corresponding to the kinematic movement of a robotic hand comprising:
providing a glove with one or more finger linkages interconnected by one or more physical joints, wherein the one or more physical joints define one or more virtual joints, and wherein the one or more physical joints and the one or more virtual joints correspond to one or more physical joints of a robotic hand, wherein kinematic movement of the one of more finger linkages of the glove conform to the one or more physical joints of the robotic hand to reduce unwanted kinematic movement that cannot be completed by the robotic hand;
capturing data by one or more sensors during the kinematic movement of the glove from user interaction with the glove; and
transmitting the captured data.

9. The method of claim 8 wherein the captured data is used for training a machine learning model for use in control of the robotic hand.

10. The method of claim 8 wherein the one or more finger linkages of the glove include one or more tactile members.

11. The method of claim 10 further comprising capturing tactile data from the one or more tactile members.

12. The method of claim 8 wherein capturing the data from kinematic movement of the one or more finger linkages is free from restrictions from kinematics of the wrist of the user.

13. The method of claim 8 wherein the one or more finger linkages includes a proximal end and a distal end, wherein the one or more virtual joints are more proximal to the proximal end than the one or more physical joints corresponding to the one or more physical joints of the robotic hand.

14. The method of claim 8 wherein the one or more finger linkages includes a proximal end and a distal end, wherein the one or more virtual joints are positioned between at least one first physical joint of the one or more physical joints adjacent the proximal end and at least one second physical joint of the one or more physical joints adjacent the distal end corresponding to the one or more physical joints of the robotic hand.

15. The method of claim 14 wherein the at least one first physical joint is transverse to the one or more virtual joints and the at least one second physical joint.

16. The method of claim 8 wherein the glove includes a plurality of the one or more finger linkages.

17. The method of claim 8 wherein the user interaction with the glove is one of direct glove use, true puppetry use, and/or simulation use.

18. A glove comprising:
a frame member;
one or more first finger linkages interconnected by one or more first physical joints and projecting from the frame member, wherein the one or more first physical joints correspond to one or more first robotic physical joints of a robotic hand;
one or more second finger linkages interconnected by one or more second physical joints and projecting from the frame member, wherein the one or more second physical joints correspond to one or more second robotic physical joints of a robotic hand;
at least one of the one or more first physical joints and/or the one or more second physical joints define one or more virtual joints, wherein the one or more virtual joints correspond to one or more third robotic physical joints of a robotic hand;
the one or more first physical joints include at least one first restriction of movement conforming to the one or more first robotic physical joints;
the one or more second physical joints include at least one second restriction of movement conforming to the one or more second robotic physical joints; and
the one or more virtual joints include at least one third restriction of movement conforming to the one or more third robotic physical joints.

19. The glove of claim 18 further comprising a wrist attachment configured to engage the forearm of the user when the one or more first finger linkages and the one or more second finger linkages are configured to engage the finger of the user, respectively, and wherein the frame member is configured to be spaced from the hand of the user.

20. The glove of claim 18 wherein the one or more first finger linkages include a distal phalange linkage connected to a middle phalange linkage, and wherein each one of the distal phalange linkage and the middle phalange linkage includes a tactile member.
